(19) United States
(12) Patent Application Publication
(10) Pub. No.: US 2015/0379642 A1
(43) Pub. Date: Dec. 31, 2015

(54) Carry-Adjusted Index Futures

(71) Applicant: Chicago Mercantile Exchange Inc., Chicago, IL (US)

(72) Inventors: Matthew Tagliani, London (GB); Scot Warren, Chicago, IL (US); John Labuszewski, Westmont, IL (US); John Nyhoff, Darien, IL (US)

(21) Appl. No.: 14/519,491

(22) Filed: Oct. 21, 2014

Related U.S. Application Data
(60) Provisional application No. 62/019,020, filed on Jun. 30, 2014.

(51) Int. Cl. G06Q 40/06; G06F 17/10

(52) U.S. Cl. CPC G06Q 40/06; G06F 17/10

(57) ABSTRACT

A calculation of a value for a carry-adjusted version of an economic index may include adjusting an equity component by a carrying cost component. The equity component may be based on a value of the economic index corresponding to the current time. The carrying cost component may be based on a carrying cost rate and a time period from the current time to a previous time. The calculation may be periodically reset to, e.g., reflect a new carrying cost rate. The carry-adjusted version of an economic index may be the underlying of a futures contract or other type of product.

### CROSS-REFERENCE TO RELATED APPLICATION

This application claim priority to U.S. provisional patent application No. 62/019,020, filed Jun. 30, 2014, and titled “Carry-Adjusted Index Futures.” Application No. 62/019,020, in its entirety, is incorporated by reference herein.

### BACKGROUND

An equity total return swap (TRS) is a type of over the counter (OTC) financial product in which one party agrees to make periodic interest payments based on a floating reference interest rate that may change from time to time (e.g., the 3 month London Interbank Offered Rate, or “LIBOR”). The other party to the TRS agrees to make periodic payments, based on the performance of one or more stocks, that includes returns based on price movement of those stocks and dividends paid by issuers of those stocks. In many cases, the TRS is periodically “reset.” During such TRS resets, the floating rate used for calculating interest rate payments may be updated (e.g., to the current LIBOR). The notional value of the swap may also be updated based on the current value of the reference equity securities. In some TRSs, the parties may exchange payments at a reset.

Although useful for various economic goals, a TRS may have numerous drawbacks. Periodic processing of payments between the parties can be administratively burdensome. Moreover, negotiating the terms of a TRS can also be burdensome. For example, parties to a TRS may have a standardized set of terms governing all such swaps, e.g., an ISDA Master Agreement. Negotiating the terms of such an agreement can be time-consuming. For these and other reasons, there remains a need for other types of products that can mimic the economic character of a TRS.

### SUMMARY

This Summary is provided to introduce a selection of concepts in a simplified form that are further described below in the Detailed Description. This Summary is not intended to identify key features or essential features of the invention.

In at least some embodiments, a value for a carry-adjusted version of an economic index may be calculated. The calculation may include adjusting an equity component by a carrying cost component. The equity component may be based on a value of the economic index corresponding to the current time. The carrying cost component may be based on a carrying cost rate and a time period from the current time to a previous time. The calculation may be periodically reset to, e.g., reflect a new carrying cost rate. The carry-adjusted version of an economic index may be the underlying of a futures contract or other type of product. Any of numerous types of economic indices may provide a value on which an equity component is based. Examples of such indices include, without limitation, stock and other equity market indices, bond market indices, commodity market indices, etc. Similarly, a carrying cost rate could represent any of numerous types of carrying costs. Examples of such costs include, without limitation, interest rates indicative of funding costs, commodity storage costs, etc.

Embodiments include, without limitation, herein-described methods for processing data associated with carry-adjusted indices and/or futures contracts based on such indices, computer systems configured to perform such methods, and non-transitory computer-readable media storing instructions executable by a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to some embodiments.

FIGS. 2A and 2B show an example of a reset of a carry-adjusted index calculation procedure.

FIG. 3 is a flow chart showing steps performed by a computer system when calculating a carry-adjusted index according to some embodiments.

FIGS. 4 and 5 are flow charts showing operations performed by a computer system according to some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment, and/or an embodiment combining software and hardware aspects. Furthermore, such aspects may take the form of a computer program product embodied as one or more non-transitory computer-readable storage media having computer-readable program code, or instructions, stored in or on that media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory, and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as but not limited to exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

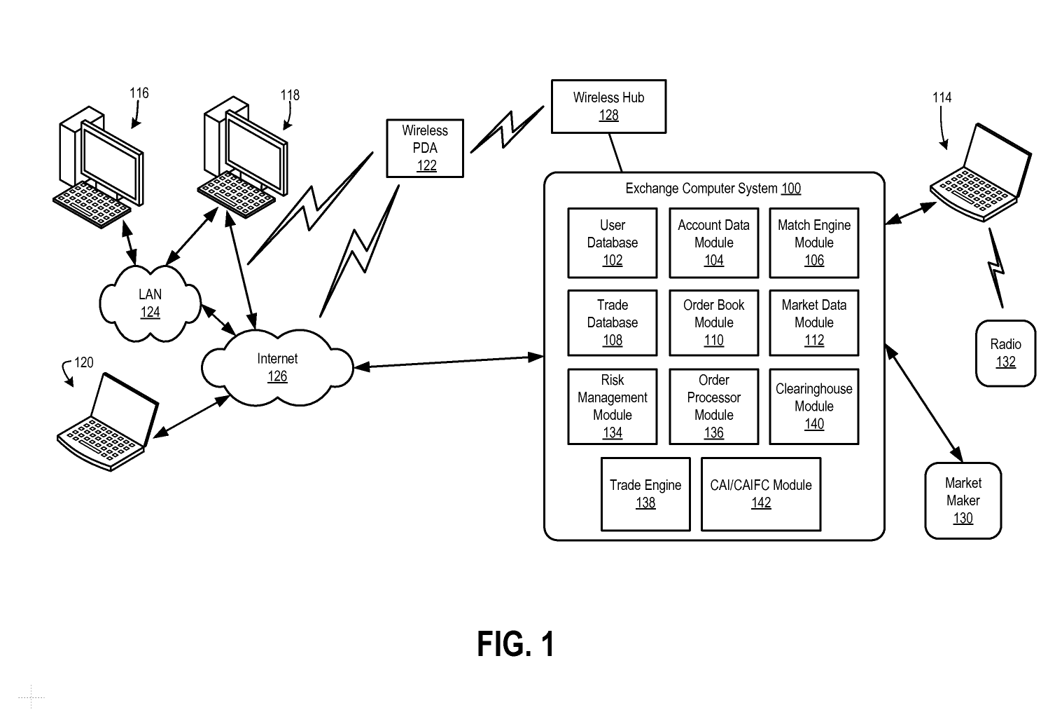

Aspects of at least some embodiments can be implemented with computer systems and computer networks that allow users to communicate trading and other information. An exemplary trading network environment for implementing systems and methods according to some embodiments is shown in FIG. 1. The implemented systems and methods can include systems and methods, such as are described herein, that facilitate data processing and other activities associated with a carry-adjusted version of an economic index and with futures contracts based on such an index.

Computer system 100 can be operated by a financial product exchange and configured to perform operations of the exchange for, e.g., trading and otherwise processing data relating to various financial products. In addition to carry-adjusted index futures contracts such as are described herein, financial products of the exchange may include, without limitation, futures contracts, options on futures contracts, other types of options, and other types of derivative contracts. Financial products traded or otherwise processed by the exchange may also include over-the-counter (OTC) products such as OTC forwards, OTC options, OTC swaps, etc. Financial products traded through the exchange may also or alternatively include other types of financial interests, including without limitation stocks, bonds and/or other securities (e.g., exchange traded funds), foreign currencies, and spot market trading of commodities.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options, and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse of the exchange that operates computer system 100. Module 140 may receive data from and/or transmit data to trade database 108 and/or other modules of computer system 100 regarding trades involving futures contracts and other financial products traded through the exchange that operates system 100. Clearinghouse module 140 may facilitate the financial product exchange (or a clearinghouse of the exchange) acting as one of the parties to every traded contract or other product. For example, computer system 100 may match an offer by party A to sell a futures contract, an option, a carry-adjusted index futures contract, or another exchange-traded financial product with a bid by party B to purchase a like exchange-traded financial product. Module 140 may then create an exchange-traded financial product between party A and the exchange clearinghouse and a second exchange-traded financial product between the exchange clearinghouse and party B. Module 140 may similarly create offsetting contracts when creating contracts as a result of an option exercise and/or may select option grantors to fulfill obligations of exercising option holders. Module 140 may also be configured to perform other clearinghouse operations. As a further example, module 140 may maintain performance bond data with regard to clearing members and/or trading customers. As part of such operations, module 140 may store and maintain data regarding the values of various futures contracts and other interests, determine mark-to-market and final settlement amounts, confirm receipt and/or payment of amounts associated with performance bond accounts, confirm satisfaction of delivery and other final settlement obligations, etc.

Exchange computer system 100 may include a CAI/CAIFC module 142. Module 142 may generate, store, and process data associated with one or more types of carry-adjusted index (CAI) and/or with one or more types of carry-adjusted index futures contract (CAIFC). Various operations performed by module 142 in at least some embodiments are further described below.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN), or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links, or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish, or any other device for connecting a computer device to the Internet. Computers 116, 118, and 120 may communicate with each other via the Internet 126 and/or LAN 124.

One or more market makers 130 may maintain a market by providing continual bid and offer prices for a derivative, security, or other type of product to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems, and fee systems.

The operations of computer devices and systems shown in FIG. 1 and described herein may be controlled by computer-executable instructions stored on one or more non-transitory computer-readable media. For example, computer device 116 may include computer-executable instructions for receiving market data from exchange computer system 100 and displaying that information to a user. As another example, module 142 and/or other modules of exchange computer system 100 may include one or more non-transitory computer-readable media storing computer-executable instructions for performing herein-described operations associated with CAI data and/or with CAIFC data. As but a further example, a computer such as computer 114, 116, 118, or 120 could calculate values for a CAI and provide those values to computer system 100 and/or to other computer systems.

Of course, numerous additional servers, computers, handheld devices, personal digital assistants, telephones, and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “computer system 100”) receives, stores, generates, and/or otherwise processes data associated with a CAIFC. As explained in further detail below, a CAI may be based on another economic index and a carrying cost that varies over time.

A CAI may be based on a “total return” index that is itself based on components such as stocks, bonds or other types of interests that may have a capital value (e.g., a price at which the instrument might be bought or sold) and that may also represent a source of income (e.g., dividends, interest). A total return index reflects both the changes in capital value for the index components and the accrued income of those index components. Well-known examples of an economic index and a total return version of that index include the Standard & Poor's 500 Index and the Standard & Poor's 500 Index Total Return Index. The Standard & Poor's 500 Index is quoted under, and will henceforth be referenced by, the ticker symbol SPX. The Standard & Poor's 500 Index Total Return Index is quoted under the ticker symbols SPTR and SPXTR and will henceforth be referenced as SPTR. The SPX is calculated based on prices of the component stocks in that index, but does not incorporate or otherwise account for dividends paid out on those stocks. The SPTR is calculated based on the prices of those component stocks, but by also assuming that dividends are reinvested into those stocks. Although various examples will be described by reference to the SPTR, embodiments include carry-adjusted indices based on other indices.

As used herein, a carrying cost represents a cost that would be associated with holding components of total return index. The carrying cost may be, for example, interest that might be paid for funds used to acquire a portfolio of stocks that mirrors components of the SPTR. As another example, a carrying cost might be charges that would be paid to store a precious metal, a commodity, or some other type of good. Total carrying cost will in general increase over time, although the rate at which the carrying cost increases may vary. Although various examples will be described by reference to the 3 month U.S. Dollar London Interbank Offered Rate (3 month USD LIBOR) as the rate at which a carrying cost may increase, embodiments include carry-adjusted indices based on other interest rates as carrying costs, as well as carry-adjusted indices in which a carrying cost is derived from a rate other than (or in addition to) an interest rate.

“Futures contract” is a generic term for certain types of standardized derivative contracts that are traded through an exchange. For each type of futures contract, definitional parameters may define terms that apply to all future contracts of that type. Those terms may include, for example, an expiration date applicable to all contracts of that type, the manner in which contracts of that type are quoted and priced, times during which contracts of that type may be traded, and the manner in which contracts of that type may be settled, i.e., the manner in which obligations under a contract of that type may be satisfied. In many cases, definitional parameters for a type of futures contract define all terms of contracts of that type except for a price term. Parties wishing to enter into a futures contract may then submit orders that contain offer or bid values for that price term, with the orders then matched based on offer and bid values. Computer system 100 may then create, or “execute,” corresponding contracts based on the matched orders.

Definitional parameters for a type of futures contract also specify a particular subject matter, or “underlying,” for all contracts of that type. As but one example, an underlying for a type of futures contract may be an agricultural or other commodity. In such a case, definitional parameters may further specify that each futures contract of that type requires delivery of a predefined amount of that commodity on or about a predefined future date. As yet another example, an underlying may be a currency, a market index, an interest rate or other economic subject matter. In such a case, definitional parameters may specify payment on a predefined date of an amount computed from the value of the underlying on some future date. As a more specific example, a futures contract may specify that one party will pay a contract price in return for receiving, at contract maturity, an amount of money equal to the value of a stock index multiplied by a contractually specified factor (e.g., the value of the SPX at maturity×$50).

There are two counterparties to a futures contract. A long counterparty (or “long”) usually refers to a futures contract party holding a long position, with that party also known as the buyer of the futures contract. For index-based futures contracts, a long may agree to pay a contract price in return for an amount based on the index value at some future time. A short counterparty (or “short”) usually refers to a futures contract party holding a short position, with that party also known as a seller of the futures contract. For index-based futures contracts, a short may agree to receive a contract price in return for paying the amount based on the future index value.

In some embodiments, computer system 100 may generate and store data that includes definitional parameters for a type of CAIFC. In at least some embodiments, CAIFCs may be traded through computer system 100 in a manner similar to other exchange-traded products. Parties wishing to acquire long CAIFC positions may submit data that indicate bids for CAIFCs and prices at which those parties are willing to enter into long CAIFC positions. Parties wishing to acquire short CAIFC positions may submit data that indicate offers for CAIFCs and prices at which those parties are willing to enter into short CAIFC positions. Computer system 100 may match bids and offers based on price and create CAIFCs at those matched prices.

For convenience, subsequent discussions may describe a CAIFC in terms of actions and obligations of the counterparties to a particular CAIFC. In some embodiments, however, and similar to other types of exchange-traded contracts, one of the counterparties to every CAIFC may be a clearinghouse (e.g., a clearinghouse of the exchange operating computer system 100). For each matched bid-offer pair, computer system 100 may thus create a first CAIFC between the matched bidder as a long and a clearinghouse as a short, as well as an identical second CAIFC between the matched offeror as a short and the clearinghouse as a long.

In at least some embodiments, definitional parameters may specify that a long to a particular type of CAIFC will receive, at contract maturity, an amount corresponding to the value of a specific CAI as of a future date (e.g., at or near contract maturity) in return for payment of the contract price. A short to such a CAIFC may have converse obligations, e.g., to pay the amount corresponding to the value of that CAI as of the future date in return for being paid the contract price. Exchange computer system 100 may calculate the value of the CAI, and/or it may receive values of the CAI from an external source.

The definitional parameters may further specify a manner in which that CAI is calculated. In some embodiments, the calculation of a CAI “I” is periodically “reset” in a manner discussed below. For convenience, a period between two adjacent resets will be referred to as an “inter-reset” period. In some embodiments, values for index I during a current inter-reset period may be calculated using Equation 1.

$${I}_{T} = {I}_{0} ( \frac{{S}_{T}}{{S}_{0}} ) - {I}_{0} ( \frac{{R}_{0} \times {D}_{0 S - TS}}{360} ) \qquad Equation 1$$

In Equation 1, I_{T} is the value of the index I at a time T. T may be, e.g., close of business on a particular calendar date. I₀ is a closing value of the index I on the last day of the immediately preceding inter-reset period. S_{T} is a value of a total value index S at time T. S₀ is a closing value of that same index S on the last day of the immediately preceding inter-reset period. In some embodiments, index S is the SPTR. R₀ is a value for an interest rate applicable to the current inter-reset period. In some embodiments, R₀ is a value of the 3 month USD LIBOR on the first day of the current inter-reset period.

D_{0S-TS} is the number of calendar days from a settlement date associated with the last day of the last inter-reset period to a settlement date associated with time T. In some embodiments, for example, and so as to reflect market conventions associated with equity markets, it is assumed that a settlement date associated with a date X is the third business day following X. Although subsequent discussion will elaborate on details of embodiments in which that settlement date convention (i.e., third business day following X) applies, such discussion merely provides an example to help illustrate various features. In other embodiments, a different settlement date convention may apply.

In some embodiments, the I calculation is reset every three months. In this manner, the I calculation further mimics schedules associated with a TRS. In some embodiments, for example, and so as to align with “roll” tendencies of holders of positions in futures products based on other indices which may be used for hedging purposes or for the purpose of facilitating trading in a CAIFC, the I calculation is reset at the end of the Tuesday preceding the third Friday in each of March, June, September, and December. In particular, S&P 500 Futures Contracts and E-mini S&P 500 Futures Contracts are traded through CME Group Inc. of Chicago, Ill., US under ticker symbols SP and ES, respectively. SP and ES contracts expire on the third Friday in each of March, June, September, and December. By Tuesdays immediately preceding the third Fridays in those months, approximately 50% of positions in SP and ES contracts that are about to expire have rolled to positions in later maturing SP or ES contracts. Although subsequent discussion will elaborate on details of embodiments in which the I calculation is reset every three months, such discussion merely provides an example to help illustrate various features. In other embodiments, an I calculation may reset at different time intervals and/or at different schedules. Such different schedules may include, e.g., resets that occur with different timings relative to expirations of one or more types of futures contracts or other financial products.

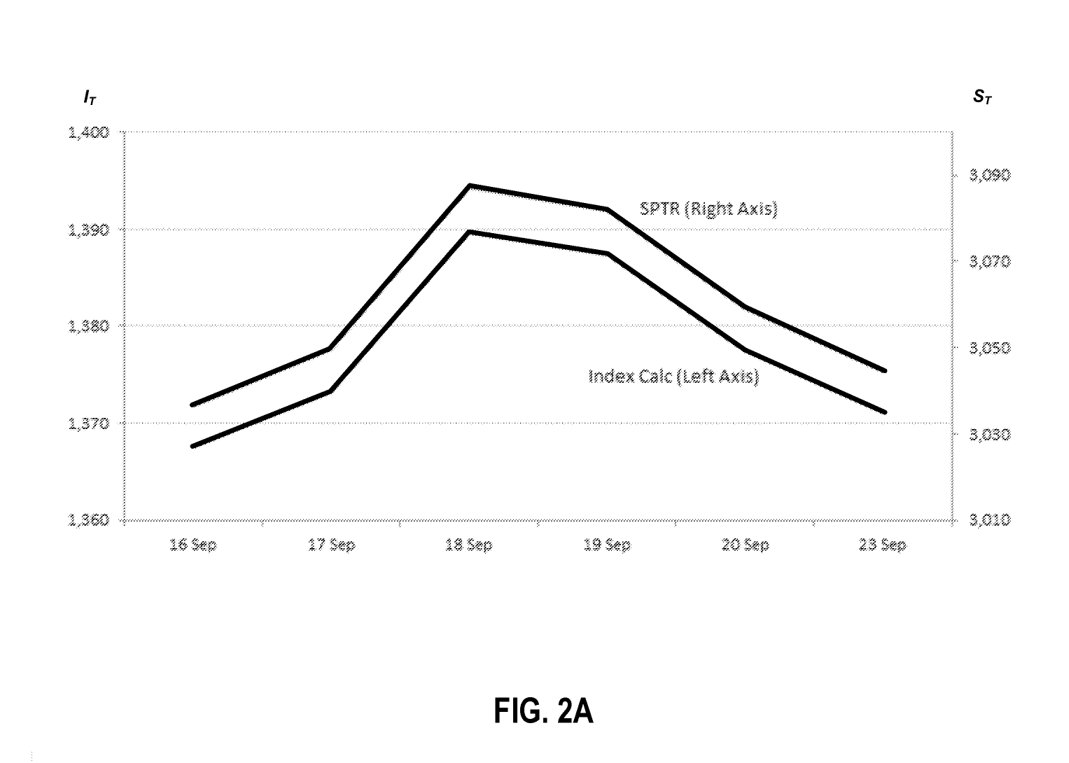

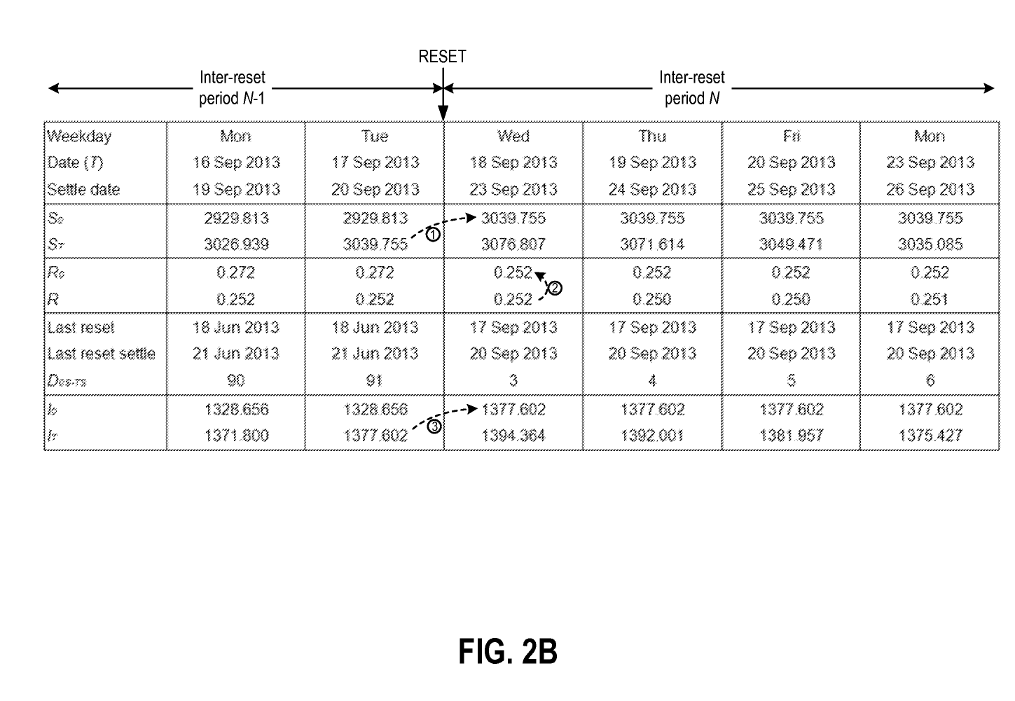

FIGS. 2A and 2B provide an example of a reset that occurs between inter-reset period N−1 and inter-reset period N. The last day of period N−1 is Tuesday, Sep. 17, 2013. The first day of period N is Wednesday, Sep. 18, 2013. FIG. 2A is a graph showing values for the SPTR (top curve) and for index I (bottom curve) from Monday, Sep. 16, 2013, to Monday, Sep. 23, 2013. FIG. 2B is a table providing values for elements of Equation 1 over that same time period. As explained in further detail below, the example of FIGS. 2A and 2B assumes that index I had a hypothetical starting value of 1000 on Jan. 3, 2012.

Each column of FIG. 2B corresponds to one of the dates identified in the row labeled “Date(T).” The settlement dates associated with dates T are contained in the next row (labeled “Settle date”). In the next row, the 2929.813 value of S₀ for September 16 and 17 represents the closing SPTR value on Jun. 18, 2013, the last day of inter-reset period N−2 (not shown in the table). The 3039.755 value of S₀ for September 18, 19, 20, and 23 represents the closing SPTR value on Sep. 17, 2013, the last day of inter-reset period N−1. The next row, labeled “S_{T},” provides the closing SPTR values on each of the days T represented in the table of FIG. 2B.

In the next row, the 0.272 value for R₀ on September 16 and 17 is a value of the 3 month USD LIBOR on the first day of inter-reset period N−1 (Jun. 19, 2013). The 0.252 value of R₀ for September 18, 19, 20, and 23 is a value of the 3 month USD LIBOR on the first day of the inter-reset period N (Sep. 18, 2013). The row labeled “R” provides values of the 3 month USD LIBOR on each of the days T represented in the table of FIG. 2B.

The row labeled “Last reset,” provides the date of the last day of the inter-reset period immediately preceding the inter-reset period within which a particular date T is contained. For September 16 and 17, which are in period N−1, the “Last reset” date is Jun. 18, 2013, the last day of period N−2. For September 18, 19, 20 and 23, which are in period N, the “Last reset” date is Sep. 17, 2013, the last day of period N−1. As indicated in the next row (“Last reset settle”), the settlement date associated with Jun. 18, 2013, is Jun. 21, 2013, and the settlement date associated with Sep. 17, 2013 is Sep. 20, 2013. The row labeled “D_{0S-TS}” contains, for each of dates T represented in the table of FIG. 2B, the number of calendar days from the settlement date associated with the last day of the preceding inter-reset period to the settlement date associated with that date T. For example, Sep. 18, 2013, is in period N and is associated with a settlement date of September 23. The settlement date associated with the last day (September 17) of period N−1 is September 20. Because there are three calendar days between September 20 and September 23, D_{0S-TS}=3 for T=18 Sep. 2013.

In the next row, the 1328.656 value of I₀ for September 16 and 17 represents the closing I value on Jun. 18, 2013, the last day of inter-reset period N−2 (not shown in the table). The 1377.602 value of I₀ for September 18, 19, 20, and 23 represents the closing I value on Sep. 17, 2013, the last day of inter-reset period N−1. The next row, labeled “I_{T},” provides the closing SPTR values on each of the days T represented in the table of FIG. 2B. Each of the I_{T} values in the table of FIG. 2B are calculated using Equation 1. For example, I_{T}(17 Sep. 2013)=1328.656*(3039.755/2929.813)−1328.656*(0.00272*91/360)=1377.602. As another example, I_{T}(18 Sep. 2013)=1377.602*(3076.807/3039.755)−1377.602*(0.00252*3/360)=1394.364.

At the reset between periods N−1 and N, and as respectively indicated in FIG. 2B by broken line arrows 1 through 3, values for S₀, R₀, and I₀ used in Equation 1 are reset to values that correspond to the time of the reset. Moreover, the reference from which D_{0S-TS} is measured is also reset to a time that corresponds to the time of the reset. Previous resets would have occurred, and future resets would occur, in a manner similar to that described above. Calculation of index I may continue indefinitely and independently of futures contracts or other products that might be based in index I.

Contingency procedures may also be established to address circumstances that might affect resets. For example, a reset might be scheduled to occur between dates X and Y. On one or both of those dates, markets might not open because of a holiday or because of a significant emergency. Contingency procedures could address such a circumstance by prescribing how values of S₀, I₀, and R₀ are to be obtained if markets do not open on a day with which one of those values is associated. As but one further example, markets might be unexpectedly closed on date X. Contingency procedures may then require that the reset occur as planned at the end of date X, with R₀ for the post reset period updated to a value of the 3 month USD LIBOR on date Y, but with S₀ and I₀ for the post reset period updated to the closing values of S and I from the last business day before date X. If markets are open on date X but are unexpectedly closed on date Y, contingency procedures may then require that the reset occur as planned at the end of date X, with S₀ and I₀ for the next period being the closing values of S and I on date X, but with R₀ post reset being a value of the 3 month UDS LIBOR on the first business day following date Y. These contingency procedures could be combined if markets are unexpectedly closed on dates X and Y. In some embodiments, in the event of unexpected market closure on date X or date Y, observations for the index calculation may be taken on the next opened business day after X or Y.

The example of FIGS. 2A and 2B assumes that index I calculation was initiated as follows. An arbitrarily selected initial value of 1000 was assigned as a closing value of I on Jan. 3, 2012 (a Tuesday). This value of I then became the first value of I₀ on Jan. 4, 2013. The closing value of the SPTR on Jan. 3, 2012, became the first value of S₀, the 3 month USD LIBOR on Jan. 4, 2012, became the first value of R₀, and settlement dates associated with Jan. 3, 2012, and Jan. 4, 2012, (Jan. 6, 2012, and Jan. 9, 2012, respectively) were used for determining the first value of D_{0S-TS}. From that point forward, I was calculated using Equation 1 and assuming resets every March, June, September and December. A first value of index I could be calculated in other ways. For example, a different first calculation date and/or initial arbitrary value could be used.

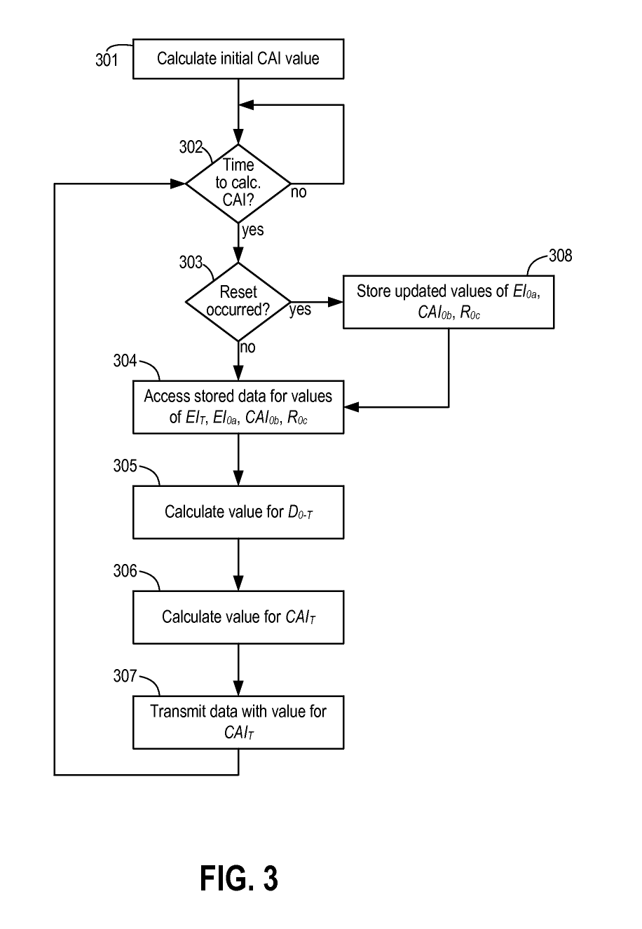

FIG. 3 is a flow chart showing steps performed by a computer system when calculating a CAI value according to some embodiments. In some such embodiments, the computer system performing the calculations may be computer system 100 operated by an exchange. In other embodiments, steps of FIG. 3 might be performed by a computer system operated by a third party that provides values of the CAI to an exchange and/or other parties.

In step 301, the computer system calculates an initial value of the CAI. In some embodiments, the initial CAI value may be calculated in a manner such as that described above. In step 302, the computer system determines if it is time to calculate a new CAI value. In some embodiments, for example, the computer system may determine in step 302 whether it is the end of a business day T. If not, the computer system repeats step 302 (“no” branch). If so (“yes” branch), the computer system proceeds to step 303.

In step 303, the computer system determines if a reset has occurred since the last calculation of the CAI closing value. In embodiments such as that described in connection with FIGS. 2A and 2B, resets may occur at the end of the Tuesday preceding the third Friday in every March, June, September, and December. In other embodiments, resets may occur on other schedules. In some such other embodiments, inter-reset periods may be of unequal duration.

If a reset has not occurred, the computer system proceeds to step 304. In step 304, the computer system accesses stored data that includes a value EI_{T} that is a current value (e.g., at the close of day T) for a separate economic index. That separate economic index may be a total return index such as the SPTR. Examples of other total return indices that might be used include, without limitation, various indices available from other providers. The accessed data may also a value EI_{0c} of that separate economic index at a time T₀ₐ corresponding to the last reset, a value CAI_{0b} of the CAI at a time T_{0b} corresponding to the last reset, and a value R_{0c} of a carrying cost rate at a time T_{0c} corresponding to the last reset. In embodiments in which a carrying cost rate is a cost of funds (e.g., an interest rate), that rate may be, e.g., a LIBOR, a U.S. Treasury funds rate, or some other interest rate subject to periodic revision.

In some embodiments, EI₀ₐ and CAI_{0b} are closing values from the last day of the last inter-reset period and R_{0c} is a value from the first day of the current reset period. In embodiments such as that described in connection with FIGS. 2A and 2B, EI₀ₐ is the closing SPTR value from the last day of the last inter-reset period, CAI_{0b} is the closing value of index I from the last day of the last inter-reset period, and R_{0c} is a 3 month USD LIBOR from the first day of the current inter-reset period. In some embodiments, however T₀ₐ and T_{0b} may be different from each other and/or T_{0c} may be a different date (e.g., the last day of the last inter-reset period).

In step 305, the computer system calculates a value D_{0-T} representing an amount of time over which a carrying cost will be calculated. In some embodiments, D_{0-T} represents a span of time between a date related to the end of the previous inter-reset period and a date related to a current date T. In some embodiments such as those described in connection with FIGS. 2A and 2B, the date related to the end of the previous inter-reset period is a settlement date three business days after the last day of the last inter-reset period and the date related to a current date T is a settlement date three business days after the current date T. In other embodiments, settlement dates may be determined in different ways. In still other embodiments, the date related to the end of the previous inter-reset period may not be a settlement date and/or the date related to a current date T may not be a settlement date.

In step 306, the computer system calculates CAI_{T}, a current value for the CAI. In some embodiments, this calculation includes calculating an equity component and a carrying cost component, with the equity component being based on the value EI_{T}, and with the carrying cost component based on R_{0c} and D_{0-T}, and then adjusting the equity component by the carrying cost component. Stated generally, the calculation may be represented as shown in Equation 2a.

CAI_{T}=f(EI_{T})−f(R_{0c},D_{0-T}) Equation 2a:

In Equation 2a, the equity component is f(EI_{T}), where f(EI_{T}) generally represents an output of a function that includes EI_{T} as an input, and the carrying cost component is f(R_{0c}, D_{0-T}), where f(R_{0c}, D_{0-T}) generally represents an output of a function that includes R_{0c} and D_{0T} as inputs. In some embodiments, the equity component is also a function of the value EI₀ₐ, resulting in Equation 2b, a more specific form of Equation 2a.

CAI_{T}=f(EI_{T},EI₀ₐ)−f2(R_{0c},D_{0-T}) Equation 2b:

In some embodiments, the equity and carrying cost components are also functions of the value CAI_{0b}, resulting in Equation 2c, an even more specific form of Equation 2c.

CAI_{T}=f(EI_{T},EI₀ₐ,CAI_{0b})−f2(R_{0c},D_{0-T},CAI_{0b}) Equation 2c:

In some embodiments, the calculation of step 306 is represented by Equation 2d.

$${CAI}_{T} = {CAI}_{0 b} ( \frac{{EI}_{T}}{{EI}_{0 a}} ) - {CAI}_{0 b} ( \frac{{R}_{0 c} \times {D}_{0 - T}}{AF} ) \qquad Equation 2 d$$

AF in Equation 2d is an optional annualization factor. Exemplary values for AF, which may depend, e.g., on the convention used for R_{0c}, include 1, 360 and 365. Equation 1 is a more specific form of Equation 2d, and in embodiments such as those described in connection with FIGS. 2A and 2B, Equation 1 is used in the calculations of step 306.

In step 307, the computer system transmits the calculated value of CAI_{T} for use in connection with further processing operations. From step 307, the computer system returns to step 302.

Returning to step 303, if the computer system determines that it is time for a rest, the computer system proceeds to step 308. In step 308, the stored value for EI₀ₐ to be accessed during performance of step 304 is updated with a new value of the separate economic index at a new time T₀ₐ corresponding to the reset that has just occurred. In a similar manner, the stored value for CAI_{0b} to be accessed during performance of step 304 is updated with a new value of the CAI at a new time T_{0b} corresponding to the reset that has just occurred. Finally, the stored value for R_{0c} to be accessed during performance of step 304 is updated with a new value of the carrying cost rate at a new time T_{0c} corresponding to the reset that has just occurred. In embodiments such as those described in connection with FIGS. 2A and 2B, updating of the stored values for EI₀ₐ, CAI_{0b}, and R_{0c} is performed by updating the values for S₀, I₀, and R₀ as described in connection with FIG. 2B and as shown in FIG. 2B by arrows 1 through 3. After completing step 308, the computer system proceeds to step 304.

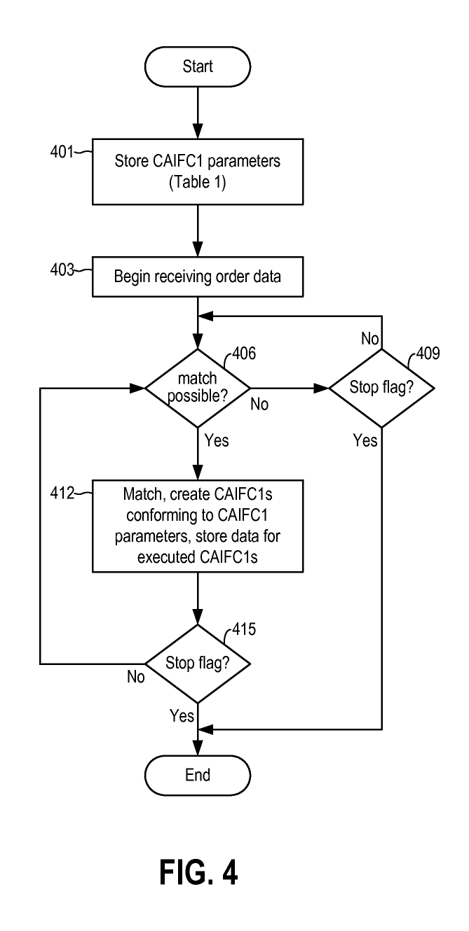

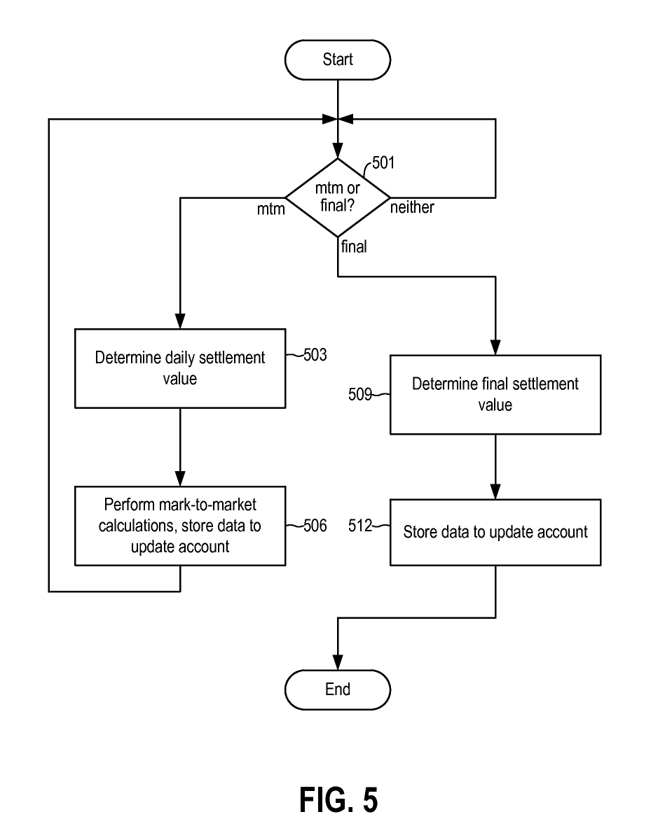

FIGS. 4 and 5 are flow charts showing operations performed in some embodiments to process data associated with CAIFCs. For convenience, the operations of FIGS. 4 and 5 are described using a hypothetical type of CAIFC known as a CAIFC1. A CAIFC1 is an exchange traded contract under which a long agrees to pay a contract price in return for receiving a payment in an amount that will be based on a value of a CAI on a future date. In some embodiments, that CAI may be an index I such as was described in connection with FIGS. 2A and 2B. A CAIFC short agrees to pay that amount in return for receiving the contract price.

FIG. 4 shows operations performed by computer system 100 in connection with establishing definitional parameters for CAIFC1s and in connection with creation of CAIFC1s conforming to those parameters. In step 401, computer system 100 stores data that includes CAIFC1 parameters. A CAIFC1 is a contract that conforms to those parameters. Table 1 summarizes a portion of the CAIFC1 parameter data stored in step 401.

TABLE 1
CAIFC1 Parameters

| | |
|---|---|
| Underlying | CAI x $<notional multiplier> |
| Obligations | <long obligations> |
| | <short obligations> |
| Quote | <quoting convention> |
| Tick size | <minimum price fluctuation increment> |
| Expiration | <date of expiration> |
| Last trade | <date when trading closes> |
| Settlement | <daily settlement procedures> |
| | <final settlement procedures> |
| CAI | <calculation methodology and/or source> |
| Fee | <exchange fees for CAIFCs> |

The data represented by the first row of Table 1 (“Underlying”) indicates that the underlying subject matter of a CAIFC1 is a product of the value of the CAI and a notional multiplier. The notional multiplier, which would be the same for all CAIFC1s, may be, e.g., $50. The “Obligations” row includes data that specifies the obligations of short and long counterparties to a CAIFC1. The long obligations require a long to pay the contract price at contract expiration in return for receipt of a sum equal to the value of the underlying at expiration (e.g., the value of the CAI at expiration multiplied by the notional multiplier). The short obligations require the short to pay the value of the underlying at contract expiration in return for receiving the contract price. In effect, one of the parties is required to pay the other the difference between the contract price and the value of the underlying at expiration.

The “Quote” row includes data that specifies how offers to buy or sell CAIFC1s are to be quoted. In some embodiments such as that described in connection with FIGS. 2A and 2B, a CAIFC1 is quoted as a number of index points. For example, and assuming a notional multiplier of $50, a quote of 1.5 index points would equate to a contract price of $75. The “Tick size” row includes data that indicates the minimum increment of price fluctuation (e.g., 0.1 index points). The “Expiration” date indicates the date on which a CAIFC1 expires (e.g., third Friday in March 2015). Different types of CAIFCs might differ based on expiration. For example, definitional parameters for a CAIFC2 might be identical to the CAIFC1 parameters, but simply specify a different expiration (e.g., third Friday in June 2015).

The “Last trade” row includes data that indicates the date and time by which trades in CAIFC1s must end (e.g., 4:15 p.m. Chicago time on the day prior to contract expiration). The “Settlement” row includes data that defines procedures for daily settlements and for final settlement. The daily settlement procedures may specify how the contract will be valued, prior to close of CAIFC1 trading, for purposes of marking to market. Those daily settlement procedures, for example, may indicate that the daily settlement valuation is based on closing trade price for other CAIFC1s if there were trades on that day, may indicate that the daily settlement valuation is based on a midpoint of offers and bids for CAIFC1s if there were no trades, and may provide methodology for determining that midpoint. The final settlement procedures may specify how a CAIFC1 underlying is valued at contract expiration. In some embodiments, the final value of a CAIFC1 is the value of the CAI at expiration. In other embodiments, and as described below, a slightly modified CAI calculation may be used to obtain a “special opening quote” (SOQ) for the CAI that is used to determine the final underlying value. The “CAI” row includes data that describes the methodology for calculating the CAI and/or a source of data that will provide CAI calculations and/or data for elements in the CAI calculation. In some embodiments, for example, the data in the CAI row may include (either explicitly or as a pointer to other data) information setting forth the calculation procedure described in connection with FIG. 3. In some such embodiments, the data in the CAI row may also or alternatively include an indicator that values for the CAI will be calculated by and received from an identified third party.

The “Fee” row may include data that defines how the exchange will charge fees for executing CAIFC1s. In some embodiments, fees for CAIFC1s are structured so as reduce undesirable opportunities for arbitrage relative to other types of index-based futures contracts. Under one such structure, fees for various types of CAIFCs are laddered so that a front month CAIFC fee is comparable to a fee for a front month contract in another index-based futures contract product (e.g., an ES contract), while longer-dated CAIFCs are priced successively higher. For example, an exchange fee for executing a CAIFC that is the n^{th} expiring contract relative to the front month may be set to 2n−1 times the front month contract fee. To illustrate this concept, assume that there are 8 types of CAIFC contracts that can be traded in January 2015: CAIFC1 expiring in March 2015, CAIFC2 expiring in June 2015, CAIFC3 expiring in September 2015, CAIFC4 expiring in December 2015, CAIFC5 expiring in March 2016, CAIFC6 expiring in June 2016, CAIFC7 expiring in September 2016, and CAIFC8 expiring in December 2016. In January 2015, a CAIFC1 is the front month contract (n=1), a CAIFC2 is the first deferred contract (n=2), etc. If the fee for executing a CAIFC1 in January 2015 is F, then the fee for executing a CAIFC2 in January 2015 is 3F ((2*2−1)*F), the fee for executing a CAIFC3 in January 2015 is 5F ((2*3−1)*F), etc. After expiration of CAIFC1s, the “n” rankings of CAIFC2 through CAIFC7 respectively decrease by one, and a new type of contract (CAIFC9 expiring in March 2017) becomes available as n=8. In April 2015, because CAIFC2 is now the front month (n=1), a fee for executing a CAIFC2 in April 2015 is now F, the fee for executing a CAIFC3 (now N=2) in April 2015 is now 3F, etc. This would continue following each expiration.

In step 403, order book module 110 of exchange computer system 100 begins receiving order data from parties desiring to enter into CAIFC1s. Computer system 100 may continue to receive such order data until the operations of FIG. 4 end. The received order data includes buy order data from parties wishing to buy (i.e., acquire long positions in) CAIFC1s and sell order data from parties wishing to sell (i.e., acquire shorts positions in) CAIFC1s. The buy order data includes bid pricing data indicating contract prices at which the submitters are willing to buy CAIFC1s. The sell order data includes offer pricing data indicating contract prices at which the submitters are willing to sell CAIFC1s.

In step 406, match engine module 106 of computer system 100 determines if any of the received buy orders can be matched with any of the received sell orders. Match engine module 106 may perform this determination based on the bid and offer prices in those orders. This matching may be performed on a first-in first-out (FIFO) basis or on some other basis and using conventional order matching algorithms used in connection with orders for existing types of futures contracts and other products. If no matches are possible, and as shown by the “no” branch from step 406, computer system 100 determines in step 409 whether a “stop” flag has been set. Such a flag may be set, for example, if the close of trading time and date for CAIFC1s has been reached. If the flag is not set, and as shown by the “no” branch from step 409, step 406 is repeated. If the stop flag has been set, and as shown by the “yes” branch from step 409, the operations of FIG. 4 end.

If computer system 100 determines in step 406 that a match is possible, and as shown by the yes branch from step 406, the match is performed in step 412. As part of step 412, computer system 100 stores data for executed CAIFC1s corresponding to the matched buy and sell orders. For each CAIFC1 buy order matched to an CAIFC1 sell order, at least two CAIFC1s are created. A first of those CAIFC1s is between the matched buyer and a clearinghouse of the exchange. The buyer is the long counterparty to that CAIFC1 and the clearinghouse is the short counterparty to that CAIFC1. A second of those CAIFC1s is between the matched seller and the clearinghouse. The seller is the short counterparty to that CAIFC1 and the clearinghouse is the long counterparty to that CAIFC1. The prices for those two CAIFC1s, which are based on the matched orders, are the same. The matched buyer and seller may not know each other's identities. As part of step 412, clearinghouse module 140 of computer system 100 stores the contract price for each of the executed CAIFC1s.

In step 415, computer system 100 again determines if the stop flag has been set. If not, and as indicated by the “no” branch from step 415, computer system 100 returns to step 406. If the stop flag has been set, and as indicated by the “yes” branch from step 415, the operations of FIG. 4 end.

FIG. 5 shows operations performed by computer system 100 in connection with each executed CAIFC1 that results from a match in step 412 of FIG. 4. Computer system 100 may simultaneously perform operations of FIG. 5 in numerous independent program threads, with each thread corresponding to a matched pair of buy and sell orders. For example, if a buy order for one CAIFC1 is matched with a sell order for one CAIFC1, computer system 100 may perform the operations of FIG. 5 in one program thread in connection with an account of the buy order submitter and separately perform the operations of FIG. 5 in another program thread in connection with an account of the sell order submitter. For convenience, the operations of FIG. 5 will be described in the context of a single CAIFC1. In some cases, however a single order matching may result in numerous pairs of CAIFC1s. For example, a buy order for 500 CAIFC1s might be matched against a sell order for 500 CAIFC1s. In such a case, computer system 100 might perform the operations of FIG. 5 in one program thread for the resulting 500 CAIFC1 long positions of the buy order submitter and separately perform the operations of FIG. 5 in another program thread for the resulting 500 CAIFC1 short positions of the sell order submitter.

In step 501 of FIG. 5, computer system 100 determines if it is time to perform a mark-to-market calculation or a final settlement calculation. If it is not time for either, and as indicated by the “neither” branch, computer system 100 repeats step 501. If it is time to perform a mark-to-market calculation, and as indicated by the “mtm” branch, computer system 100 proceeds to step 503 and determines a daily settlement value for the executed CAIFC1 based on the daily settlement procedures set forth in the CAIFC1 parameter data. Computer system 100 then proceeds to step 506 and performs mark-to-market calculations to determine the amount by which an account associated with the holder of the executed contract is to be credited or debited based on a change in contract value. As part of step 506, computer system 100 stores data to update that account and may transmit data indicating the update (and amount thereof). After step 506, computer system 100 returns to step 501.

If computer system 100 determines in step 501 that it is time to perform a final settlement calculation, and as indicated by the “final” branch from step 501, computer system proceeds to step 509. In step 509, computer system 100 determines a final settlement value for the executed CAIFC1 based on the final settlement procedures set forth in the CAIFC1 parameter data. This final settlement value is equal to the notional multiplier times a CAI value as of the contract expiration.

In some embodiments, and as described above, a modified CAI calculation may be used when calculating a final settlement value. Because some governmental regulations require that a final settlement price be based on an opening index price, the CAI calculation may be modified to produce an SOQ CAI on the expiration date. In particular, the CAI calculation methodology discussed in connection with FIG. 3 can be adjusted to so that EI_{T} is an opening value of separate economic index on the expiration date instead of the closing value of that index on the expiration date.

The CAI calculation for final settlement may also or alternatively be modified to account for carrying cost rate mismatches during the time between the reset immediately prior to CAIFC1 expiration and the date on which a CAIFC1 is finally settled. For some types of CAIFCs, traders may hedge their positions by entering into other types of index-based futures positions. At the time a CAIFC and a hedge position are entered, a carrying cost rate used in the CAI calculation and a carrying cost rate implicit in the hedge position contract may be the same. Moreover, the hedge position contract and the CAIFC may expire at the same time. If a reset occurs between the time of entry into the CAIFC and hedge contract and the time those contracts expire together, however, there will be a mismatch in the carrying cost rates associated with the CAIFC and the hedge contract.

To further illustrate this, assume a CAIFC1 is based on index I as described in connection with FIGS. 2A and 2B and that party A enters into a CAIFC1 position in February 2015. At the same time, party A executes an ES futures contract as a hedge. In general, a market value of an ES futures contract is based on a comparison of what would be received under the contract versus buying component stocks of the SPX, the index underlying that ES contract. The SPX does not incorporate dividends and makes no adjustment for the time value of money. A party buying an ES contract will not receive the dividends the party would receive if that party bought the stocks in the SPX. Accordingly, the price paid for an ES contract is based, in part, on the price that the party would pay for those stocks minus the dividends forgone by entering the ES contract. However, and ignoring performance bond requirements and marking to market, an ES contract purchaser does not have to pay until that ES contract expires. Thus, the futures contract purchaser retains the time value of the cash that would be used to buy the stocks if they were purchased instead of the ES contract. As a result, a price for an ES contract is based on a value of the stocks in the index, less a value of dividends that will not be collected, plus a value of interest on the funds that would otherwise be used to buy stocks. Stated differently, implicit in an ES contract value is a net funding cost as of the time the ES contract is executed.

Because party A executes the CAIFC1 and the ES contract at the same time in February 2015, both are based on interest rates as of the time those contracts are executed. Although the CAI may be calculated during February 2015 based on a 3 month USD LIBOR from December 2014, party A would have based its decision to enter a CAIFC1, and would have based the price at which it was willing to enter that CAIFC1, on current funding rates. When the CAI calculation is reset in March 2015, however, the 3 month USD LIBOR used in the CAI calculation may change. As a result, there will be a mismatch between the funding rates relied upon for the CAIFC1 and the ES contracts. Although this rate mismatch may be small and may only apply for a short time (e.g., the 5 days between the reset and the settlement of the CAIFC1 and the ES contracts on the Monday following the third Friday in March 2015), it can cause significant effects for large portfolios.

Equation 3 is an example of a modified CAI calculation to obtain an SOQ value of a CAI for final settlement in embodiments such as those described in connection with FIGS. 2A and 2B.

$${I}_{SOQ} = {I}_{0} ( \frac{{S}_{SOQ}}{{S}_{0}} ) - {I}_{0} ( \frac{{R}_{0 - 1} \times {D}_{0 S - TS}}{360} ) \qquad Equation 3$$

In Equation 3, I_{SOQ} is the SOQ value of the index used for final settlement of the CAIFC1. I₀, S₀, and D_{0S-TS} have the same meanings as in Equation 1. S_{SOQ} is an opening value of the SPTR on the day that the CAIFC1 expires. An opening value of an SPTR for a particular day is calculated in a manner similar to a closing value for that same day, but instead uses opening prices for the SPTR component stocks on that day instead of closing prices for those stocks. R₀₋₁ is the value for the 3 month USD LIBOR that was used in calculation of index I prior to the most recent reset. If I_{SOQ} is being calculated on Sep. 20, 2013, for example, R₀₋₁ has a value of 0.272 (see FIG. 2B).

In at least some embodiments, an SOQ value of a CAI would only be used in connection with valuation of expiring futures contracts based on that CAI, and the unmodified CAI value would be calculated on that expiry date and used for other purposes. In some embodiments, an SOQ value of a CAI may be calculated in another manner. In some embodiments, an SOQ value of a CAI may be calculated by, and computer system 100 may receive those SOQ values of the CAI from, a computer system of a third party.

In additional embodiments, an SOQ value of a CAI is not used at all. Instead, the CAI used to determine final value of a CAIFC could be calculated in the same manner by which values for the CAI are obtained at other times. Stated differently, values for a CAI may be calculated continuously and in the same manner (e.g., as described in connection with FIG. 3); when a particular contract expires and a final value is determined, that final value may be determined using whatever value the CAI may have at expiration.

After calculating the final settlement value in step 509, computer system 100 proceeds to step 512. In step 512, computer system 100 may store data to update an account of the CAIFC1 holder to reflect the final value. As with final settlement performed in connection with other types of futures contracts, this update may represent an account decrease that requires the holder to deposit additional funds or may represent an account increase that the holder can withdraw.

Although the preceding description of FIGS. 4 and 5 focused on operations performed in connection with a single type of CAIFC, computer system 100 could generate and store data representing definitional parameters for each of numerous types of CAIFCs. Computer system 100 could perform operations, similar to those described herein, as to each of those CAIFC types and as to individual instances of each of those CAIFC types.

Additional embodiments include numerous variations on the exemplary features described thus far.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
accessing, by a computer system, data indicating a value of an economic index corresponding to a current time;
calculating, by the computer system, a value for a carry-adjusted version of the economic index, wherein the calculation includes adjusting an equity component by a carrying cost component, wherein the equity component is based on the value of the economic index corresponding to the current time, and wherein the carrying cost component is based on a carrying cost rate and a time period from the current time to a previous time; and
transmitting, by the computer system, the calculated value for the carry-adjusted version of the economic index.

2. The method of claim 1, wherein
the accessing step comprises accessing data indicating a value of the economic index corresponding to a first time prior to the current time, data indicating a value of the carry-adjusted version of the economic index corresponding to a second time prior to the current time, and a value of the carrying cost rate corresponding to a third time prior to the current time,
the calculating step comprises calculating the equity component based on the value of the economic index corresponding to the current time, the value of the economic index corresponding to the first time prior to the current time, and the value of the carry-adjusted version of the economic index corresponding to the second time prior to the current time, and
the calculating step further comprises calculating the carrying cost component based on the value of the carrying cost rate corresponding to the third time prior to the current time, the value of the carry-adjusted version of the economic index corresponding to the second time prior to the current time, and the time period from the current time to the previous time.

3. The method of claim 2, further comprising resetting, prior to the current time, the calculation of the carry-adjusted version of the economic index by updating stored data values to include the value of the economic index corresponding to the first time prior to the current time, the value of the carry-adjusted version of the economic index corresponding to the second time prior to the current time, and the value of the carrying cost rate corresponding to the third time prior to the current time, and wherein
the first time prior to the current time, the second time prior to the current time, and the third time prior to the current time are times associated with a time of the resetting.

4. The method of claim 1, further comprising resetting, at repeating intervals, values in a calculation of the carry-adjusted version of the economic index, and wherein
each pair of adjacent occurrences of the resetting is separated by an inter-reset period,
the economic index is a total return index, and
a value for the carry-adjusted version of the economic index at an arbitrary time T during an inter-reset period N is calculated according to
$${I}_{T} = {I}_{0} ( \frac{{S}_{T}}{{S}_{0}} ) - {I}_{0} ( \frac{{R}_{0} \times {D}_{0 S - TS}}{360} ) ,$$
where I_{T} is the value of the carry-adjusted version of the economic index at time T, I₀ is a closing value of the carry-adjusted version of the economic index at the end of the immediately preceding inter-reset period N−1, S_{T} is the value of the economic index at time T, S₀ is a value of the economic index at the end of the immediately preceding inter-reset period N−1, R₀ is the carrying cost rate and is an interest rate corresponding to a time at the beginning of the inter-reset period N, and D_{0S-TS} is a number of business days from a settlement date associated with the last business day of inter-reset period N−1 to a settlement date associated with time T.

5. The method of claim 1, wherein the economic index is a total return index.

6. The method of claim 5, wherein the carrying cost rate is an interest rate.

7. A method comprising:
receiving, at a computer system, buy order data representing a bid price for a carry-adjusted index futures contract conforming to carry-adjusted index futures contract parameters and sell order data representing an offer price for a carry-adjusted index futures contract conforming to the carry-adjusted index futures contract parameters;
matching, by the computer system, the buy order data and the sell order data; and
storing, by the computer system and as a result of the matching, data representing an executed carry-adjusted index futures contract.

8. The method of claim 7, further comprising storing, at the computer system, data containing the carry-adjusted index futures contract parameters, wherein the carry-adjusted index futures contract parameters specify that a carry-adjusted index futures contract conforming to the carry-adjusted index futures contract parameters is based on a carry-adjusted version of an economic index calculated for a time T by adjusting an equity component by a carrying cost component, wherein the equity component is based on a value of the economic index corresponding to the time T, and wherein the carrying cost component is based on a carrying cost rate and a time period from the time T to a previous time.

9. The method of claim 8, further comprising:
calculating, by the computer system, a final value for the executed carry-adjusted index futures contract based on a modified carry-adjusted index futures contract value, wherein the modified carry-adjusted index futures contract value is based on a value of the carrying cost rate applicable to a previous time and not applicable to the time T.

10. A computer system comprising:
at least one processor; and
at least one non-transitory memory, wherein the at least one non-transitory memory stores instructions that, when executed, cause the computer system to perform steps that include
accessing data indicating a value of an economic index corresponding to a current time,
calculating a value for a carry-adjusted version of the economic index, wherein the calculation includes adjusting an equity component by a carrying cost component, wherein the equity component is based on the value of the economic index corresponding to the current time, and wherein the carrying cost component is based on a carrying cost rate and a time period from the current time to a previous time, and
transmitting the calculated value for the carry-adjusted version of the economic index.

11. The computer system of claim 10, wherein
the accessing step comprises accessing data indicating a value of the economic index corresponding to a first time prior to the current time, data indicating a value of the carry-adjusted version of the economic index corresponding to a second time prior to the current time, and a value of the carrying cost rate corresponding to a third time prior to the current time,
the calculating step comprises calculating the equity component based on the value of the economic index corresponding to the current time, the value of the economic index corresponding to the first time prior to the current time, and the value of the carry-adjusted version of the economic index corresponding to the second time prior to the current time, and
the calculating step further comprises calculating the carrying cost component based on the value of the carrying cost rate corresponding to the third time prior to the current time, the value of the carry-adjusted version of the economic index corresponding to the second time prior to the current time, and the time period from the current time to the previous time.

12. The computer system of claim 11, wherein the at least one non-transitory memory further stores executable instructions that, when executed, cause the computer system to perform a step that comprises resetting, prior to the current time, the calculation of the carry-adjusted version of the economic index by updating stored data values to include the value of the economic index corresponding to the first time prior to the current time, the value of the carry-adjusted version of the economic index corresponding to the second time prior to the current time, and the value of the carrying cost rate corresponding to the third time prior to the current time, and wherein
the first time prior to the current time, the second time prior to the current time, and the third time prior to the current time are times associated with a time of the resetting.

13. The computer system of claim 10, wherein the at least one non-transitory memory further stores executable instructions that, when executed, cause the computer system to perform a step that comprises resetting, at repeating intervals, values in a calculation of the carry-adjusted version of the economic index, and wherein
each pair of adjacent occurrences of the resetting is separated by an inter-reset period,
the economic index is a total return index, and
a value for the carry-adjusted version of the economic index at an arbitrary time T during an inter-reset period N is calculated according to
$${I}_{T} = {I}_{0} ( \frac{{S}_{T}}{{S}_{0}} ) - {I}_{0} ( \frac{{R}_{0} \times {D}_{0 S - TS}}{360} ) ,$$
where I_{T} is the value of the carry-adjusted version of the economic index at time T, I₀ is a closing value of the carry-adjusted version of the economic index at the end of the immediately preceding inter-reset period N−1, S_{T} is the value of the economic index at time T, S₀ is a value of the economic index at the end of the immediately preceding inter-reset period N−1, R₀ is the carrying cost rate and is an interest rate corresponding to a time at the beginning of the inter-reset period N, and D_{0S-TS} is a number of business days from a settlement date associated with the last business day of inter-reset period N−1 to a settlement date associated with time T.

14. The computer system of claim 10, wherein the economic index is a total return index.

15. The computer system of claim 14, wherein the carrying cost rate is an interest rate.

16. The computer system of claim 10, wherein the at least one non-transitory memory further stores executable instructions that, when executed, cause the computer system to perform steps that comprise
receiving buy order data representing a bid price for a carry-adjusted index futures contract and sell order data representing an offer price for a carry-adjusted index futures contract,
matching the buy order data and the sell order data,
storing, as a result of the matching, data representing an executed carry-adjusted index futures contract,
determining a final settlement value for the executed carry-adjusted index futures contract based on the transmitted calculated value for the carry-adjusted version of the economic index, and
storing data to update an account associated with a holder of the executed carry-adjusted index futures contract.

17. The computer system of claim 10, further comprising an additional computer comprising at least one additional processor and at least one additional non-transitory memory, wherein the at least one additional non-transitory memory stores instructions that, when executed, cause the additional computer to perform steps that include
receiving buy order data representing a bid price for a carry-adjusted index futures contract and sell order data representing an offer price for a carry-adjusted index futures contract,
matching the buy order data and the sell order data,
storing, as a result of the matching, data representing an executed carry-adjusted index futures contract,
determining a final settlement value for the executed carry-adjusted index futures contract based on the transmitted calculated value for the carry-adjusted version of the economic index, and
storing data to update an account associated with a holder of the executed carry-adjusted index futures contract.

18. A computer system comprising:
at least one processor; and
at least one non-transitory memory, wherein the at least one non-transitory memory stores instructions that, when executed, cause the computer system to perform steps that include
receiving buy order data representing a bid price for a carry-adjusted index futures contract conforming to carry-adjusted index futures contract parameters and sell order data representing an offer price for a carry-adjusted index futures contract conforming to the carry-adjusted index futures contract parameters,
matching the buy order data and the sell order data, and
storing, as a result of the matching, data representing an executed carry-adjusted index futures contract.

19. The computer system of claim 18, wherein the at least one non-transitory memory further stores executable instructions that, when executed, cause the computer system to perform a step that comprises storing data containing the carry-adjusted index futures contract parameters, wherein the carry-adjusted index futures contract parameters specify that a carry-adjusted index futures contract conforming to the carry-adjusted index futures contract parameters is based on a carry-adjusted version of an economic index calculated for a time T by adjusting an equity component by a carrying cost component, wherein the equity component is based on a value of the economic index corresponding to the time T, and wherein the carrying cost component is based on a carrying cost rate and a time period from the time T to a previous time.

20. The computer system of claim 19, wherein the at least one non-transitory memory further stores executable instructions that, when executed, cause the computer system to perform a step that comprises calculating a final value for the executed carry-adjusted index futures contract based on a modified carry-adjusted index futures contract value, wherein the modified carry-adjusted index futures contract value is based on a value of the carrying cost rate applicable to a previous time and not applicable to the time T.
